(19) United States
(12) Patent Application Publication
(10) Pub. No.: US 2015/0287495 A1
(43) Pub. Date: Oct. 8, 2015

(54) COMPOSITE SUBSTRATE

(71) Applicant: AZOTEK CO., LTD., Taoyuan Hsien (TW)

(72) Inventor: Hung-Jung LEE, Taoyuan Hsien (TW)

(21) Appl. No.: 14/477,884

(22) Filed: Sep. 5, 2014

(30) Foreign Application Priority Data
Apr. 8, 2014 (TW) 103112888

(51) Int. Cl. H01B 7/02

(52) U.S. Cl. CPC H01B 7/02

(57) ABSTRACT

A composite substrate including a conductive layer and a hole-containing insulating layer is provided. The hole-containing insulating layer is disposed on the conductive layer and has a plurality of holes extending from a surface of the hole-containing insulating layer along a thickness direction.

### RELATED APPLICATIONS

This application claims priority to Taiwan Application Serial Number 103112888, filed Apr. 8, 2014 which is herein incorporated by reference.

### BACKGROUND

1. Field of invention

The present disclosure relates to a composite substrate.

2. Description of Related Art

Since electronic products of the new generation tend to compact size and need to have ability of high frequency transmission, a circuit board should have high wiring density and materials of the circuit board should meet more stringent requirements. Generally, high frequency electronic components are bonded to the circuit board. In order to maintain transmission rate and completeness of transmitted signals, a substrate of the circuit board should have low dielectric constant and dissipation factor. Accordingly, how to develop a material having low dielectric constant and dissipation factor for manufacturing of a high frequency circuit board is presently a problem that researchers of the technical field need to address.

### SUMMARY

The present disclosure provides a composite substrate including a conductive layer and a hole-containing insulating layer. The hole-containing insulating layer is disposed on the conductive layer and has a plurality of holes extending from a surface of the hole-containing insulating layer along a thickness direction. The hole-containing insulating layer has the holes filled with air, which has dielectric constant of about 1, such that dielectric constant of the hole-containing insulating layer is lower than that of an insulating layer without holes, so as to meet needs of the dielectric constant of the insulating layer and solve the problem that researchers of the technical field need to address.

According to one embodiment of the present disclosure, the holes are through holes or blind holes.

According to one embodiment of the present disclosure, the composite substrate is a composite substrate for high frequency applications.

According to one embodiment of the present disclosure, the composite substrate further includes an adhesive layer interposed between the conductive layer and the hole-containing insulating layer.

According to one embodiment of the present disclosure, the composite substrate further includes another conductive layer covering the surface of the hole-containing insulating layer.

According to one embodiment of the present disclosure, the conductive layer is made of copper, aluminum, iron, silver, palladium, nickel, chromium, molybdenum, tungsten, zinc, chromium, manganese, cobalt, gold, tin, lead, stainless steel or a combination thereof.

According to one embodiment of the present disclosure, the hole-containing insulating layer is made of thermosetting polyimide, thermoplastic polyimide, liquid crystal polymer (LCP), polyethylene terephthalate (PET), Teflon, polyethylene (PE), polypropylene (PP), polystyrene (PS), polyvinyl chloride (PVC), polyimide, acrylic resin, acrylonitrile-butadiene-styrene (ABS) resin, phenolic resin, epoxy resin, polyester, silicone, polyurethane (PU), polycarbonate (PC), butyl rubber or a combination thereof.

According to one embodiment of the present disclosure, the composite substrate further includes a functional adhesive filled in the holes, and the functional adhesive is a heat conductive adhesive, an electrically conductive adhesive or a combination thereof.

According to one embodiment of the present disclosure, the functional adhesive further covers the surface of the hole-containing insulating layer.

According to one embodiment of the present disclosure, the heat conductive adhesive has a plurality of heat conductive particles, and the heat conductive particles are boron nitride, aluminum nitride, aluminum oxide, silicon carbide, zinc oxide or a combination thereof.

According to one embodiment of the present disclosure, the electrically conductive adhesive has a plurality of electrically conductive substances, which are copper, aluminum, iron, silver, palladium, nickel, chromium, molybdenum, tungsten, zinc, chromium, manganese, cobalt, gold, tin, lead, stainless steel or a combination thereof.

The present disclosure also provides a hole-containing insulating layer for high frequency applications having a plurality of holes extending from a surface of the hole-containing insulating layer along a thickness direction, in which the holes are through holes or blind holes.

### BRIEF DESCRIPTION OF THE DRAWINGS

The invention can be more fully understood by reading the following detailed description of the embodiment, with reference made to the accompanying drawings as follows:

FIG. 1 is a cross-sectional view of a composite substrate according to one embodiment of the present disclosure.

FIG. 2 is a cross-sectional view of a composite substrate according to one embodiment of the present disclosure.

FIG. 3 is a cross-sectional view of a composite substrate according to one embodiment of the present disclosure.

FIG. 4 is a cross-sectional view of a composite substrate according to one embodiment of the present disclosure.

FIG. 5 is a cross-sectional view of a composite substrate according to one embodiment of the present disclosure.

FIG. 6 is a cross-sectional view of a composite substrate according to one embodiment of the present disclosure.

FIG. 7 is a cross-sectional view of a hole-containing insulating layer for high frequency applications according to one embodiment of the present disclosure.

FIG. 8 is a cross-sectional view of a hole-containing insulating layer for high frequency applications according to one embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

Generally, a substrate of a circuit board for high frequency transmission should have low dielectric constant and dissipation factor. The smaller the dielectric constant of the substrate is, the higher the signal transmission rate is since the signal transmission rate of the substrate is inversely proportional to square root of the dielectric constant of the substrate. In another aspect, low dissipation factor represents less loss during signal transmission, and thus the material having low dissipation factor can provide better signal transmission quality.

In order to provide a substrate having further low dielectric constant and dissipation factor, the present disclosure provides a composite substrate including a conductive layer and a hole-containing insulating layer. The hole-containing insulating layer has a plurality of holes filled with air, which has dielectric constant of about 1, such that dielectric constant of the hole-containing insulating layer is lower than that of an insulating layer without holes, so as to meet needs of dielectric constant of the insulating layer in the field of a high frequency substrate. In other words, the composite substrate can be a composite substrate for high frequency applications. The embodiments of the composite substrate are described below in detail, but not limited thereto.

FIG. 1 is a cross-sectional view of a composite substrate according to one embodiment of the present disclosure. The composite substrate includes a conductive layer 110 and a hole-containing insulating layer 120.

In one embodiment, the conductive layer 110 is made of copper, aluminum, iron, silver, palladium, nickel, chromium, molybdenum, tungsten, zinc, chromium, manganese, cobalt, gold, tin, lead, stainless steel or a combination thereof, but not limited thereto. In one embodiment, the conductive layer 110 has a thickness of 5 microns to 70 microns. However, the thickness of the conductive layer 110 may be appropriately selected according to the use of the composite substrate, and thus the thickness of the conductive layer 110 is not limited to the above embodiment.

The hole-containing insulating layer 120 is disposed on the conductive layer 110 and has a plurality of holes 120a extending from a surface of the hole-containing insulating layer 120 along a thickness direction Dt of the hole-containing insulating layer 120. As shown in FIG. 1, an extension direction of the hole 120a is substantially parallel to the thickness direction Dt. However, in other embodiments, the hole may obliquely extend into the substrate; that is, there is an included angle between the extension direction of the hole 120a and the thickness direction, which is less than 90 degrees. The hole 120a may be formed using any patterning process, such as CNC mechanical drilling, micro punching using a mold, laser drilling or lithography and etching processes, etc. The hole 120a may be through hole or blind hole, which can be formed by adjusting process parameters of the above patterning process. In the embodiment, as shown in FIG. 1, the hole 120a is a through hole. Therefore, a depth of the hole 120a is equal to a thickness t1 of the hole-containing insulating layer 120. The thickness t1 of the hole-containing insulating layer 120 may be appropriately adjusted according to feature requirements (e.g., requirements of electrical properties) and thus not limited. However, in one embodiment, the thickness t1 of the hole-containing insulating layer 120 is in a range of 5 microns to 260 microns. In addition, a diameter d of the hole 120a is also not limited.

The hole 120a has any shape in a top view, such as polygon, L-shape, cross-shape or star shape, but not limited thereto. In addition, in one embodiment, in a top view, an aperture ratio (i.e., area of all of the holes/total area of the surface of the hole-containing insulating layer) is greater than 5%. In another aspect, the hole 120a has any shape in a side view, such as rectangle, cone or trapezoid, but not limited thereto. In the embodiment, the hole 120a has a rectangle shape in a side view, as shown in FIG. 1.

In one embodiment, the hole-containing insulating layer 120 is made of thermosetting polyimide, thermoplastic polyimide (TPI) liquid crystal polymer (LCP), polyethylene terephthalate (PET), Teflon, polyethylene (PE), polypropylene (PP), polystyrene (PS), polyvinyl chloride (PVC), polyamide, acrylic resin, acrylonitrile-butadiene-styrene (ABS) resin, phenolic resin, epoxy resin, polyester, silicone, polyurethane (PU), polycarbonate (PC), butyl rubber or a combination thereof. The above materials almost have dielectric constant greater than or equal to 2. The present disclosure provides the hole-containing insulating layer 120 having dielectric constant less than 2 by combining the holes 120 and the above material to meet needs of dielectric constant of an insulating layer of the field of a high frequency substrate.

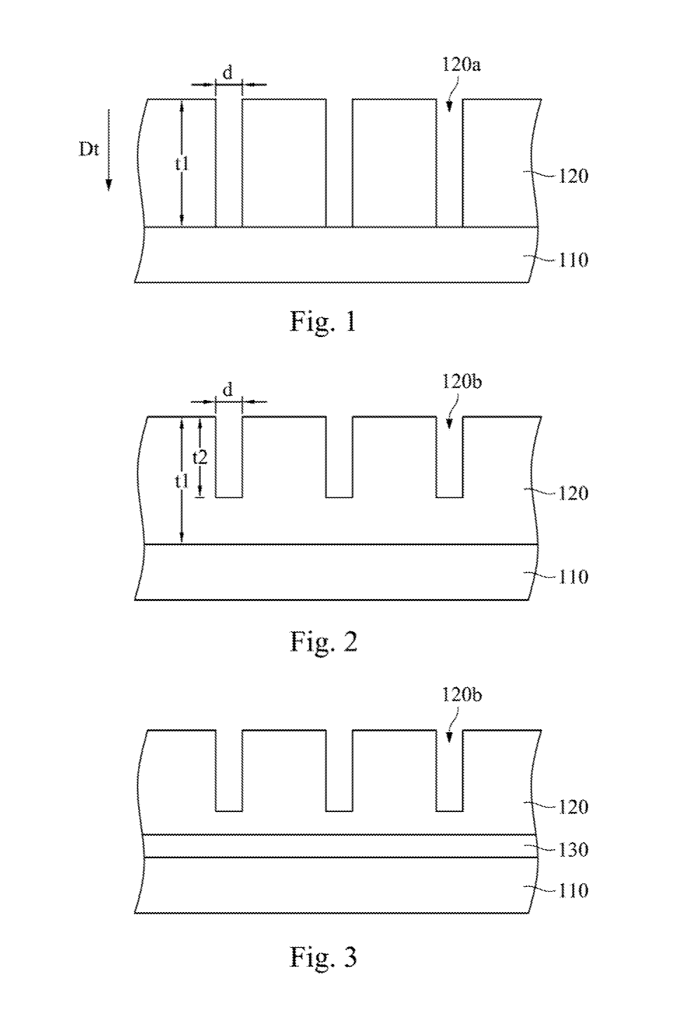

FIG. 2 is a cross-sectional view of a composite substrate according to one embodiment of the present disclosure. As shown in FIG. 2, the composite substrate includes a conductive layer 110 and a hole-containing insulating layer 120. The difference between the composite substrates of FIGS. 2 and 1 is that holes 120b of the hole-containing insulating layer 120 of FIG. 2 are blind holes, which may be fabricated by laser drilling process. In one embodiment, a depth t2 of the hole blind hole) 120b is 5-80% of a thickness t1 of the hole-containing insulating layer 120.

FIG. 3 is a cross-sectional view of a composite substrate according to one embodiment of the present disclosure. The difference between the composite substrates of FIGS. 3 and 2 is that the composite substrate of FIG. 3 further includes an adhesive layer 130 interposed between the conductive layer 110 and the hole-containing insulating layer 120. The adhesive layer 130 is used to provide good adhesion between the conductive layer 110 and the hole-containing insulating layer 120. The adhesive layer 130 may be thermosetting adhesive, hybrid adhesive or pressure sensitive adhesive. The adhesive layer 130 may be made of epoxy resin, phenoxy resin, acrylic resin, polyurethane resin, silicone rubber-based resin, p-xylene resin, bismaleimide resin, polyimide resin or a mixture thereof. The adhesive layer 130 may have a thickness in a range of 3 microns to 50 microns.

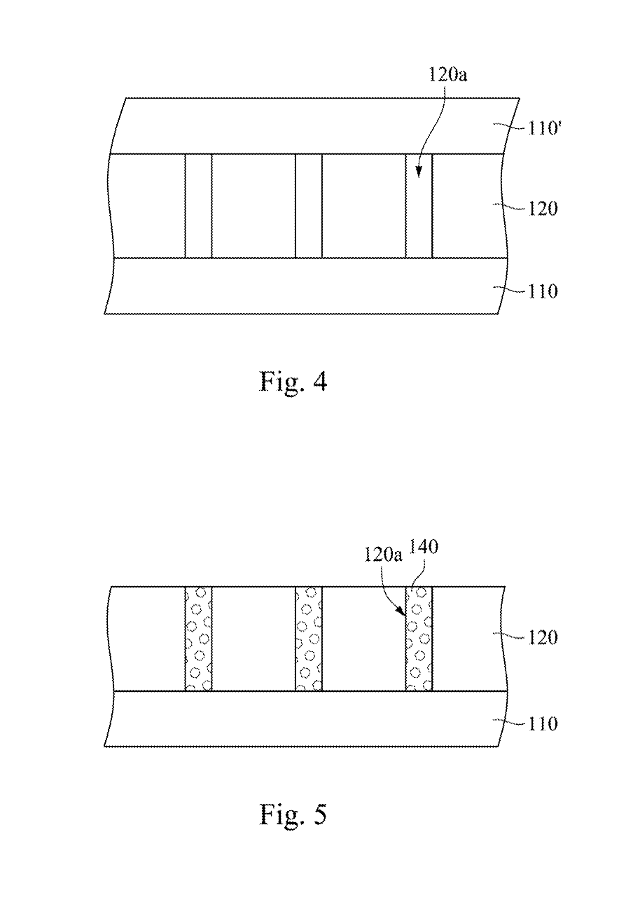

FIG. 4 is a cross-sectional view of a composite substrate according to one embodiment of the present disclosure. The difference between the composite substrates of FIGS. 4 and 1 is that the composite substrate of FIG. 4 further includes another conductive layer 110′ covering the surface of the hole-containing insulating layer 120. The material of the conductive layer 110′ may be the same as that of the conductive layer 110 of the above embodiments, and thus omitted herein.

FIG. 5 is a cross-sectional view of a composite substrate according to one embodiment of the present disclosure. The difference between the composite substrates of FIGS. 5 and 1 is that the composite substrate of FIG. 5 further includes a functional adhesive 140 filled in the holes, and the functional adhesive may be a heat conductive adhesive, an electrically conductive adhesive, a combination thereof or an adhesive with other functions. Therefore, the composite substrate of FIG. 5 may exhibit other functions, such as heat conduction or electrical conduction.

For example, when the functional adhesive 140 is the heat conductive adhesive filled in the holes 120a of FIG. 5, the composite substrate can exhibit z-direction (i.e., thickness direction) heat conduction. Such composite substrate may be applied in a field of heat dissipation, such as a heat dissipation substrate of light emitting diodes. The heat conductive adhesive may include heat conductive particles and an adhesive. In one embodiment, the heat conductive particles are boron nitride, aluminum nitride, aluminum oxide, silicon carbide, zinc oxide or a combination thereof. The size of the heat conductive particle is not limited. However, in one embodiment, a ratio of the diameter of the heat conductive particle to a depth of a hole (e.g., through hole or blind hole) is less than 3/10. The adhesive may be resin with flowability or resin dissolved in a solvent. Specifically, the resin may be poly amic acid, LCP, PET, Teflon, PE, PP, PS, PVC, polyamide, acrylic resin, ABS resin, phenolic resin, epoxy resin, polyester, silicone, PU, PC, butyl rubber or a combination thereof.

When the functional adhesive 140 is the electrically conductive adhesive filled in the holes 120a of FIG. 5, the composite substrate can exhibit z-direction electrical conduction. The electrically conductive adhesive may include electrically conductive substances and an adhesive. In one embodiment, the electrically conductive substances are copper, aluminum, iron, silver, palladium, nickel, chromium, molybdenum, tungsten, zinc, chromium, manganese, cobalt, gold, tin, lead, stainless steel or a combination thereof. The electrically conductive substance may be in a form of powder or wire, such as silver powder, copper powder, nickel powder, silver-covering copper powder, silver-covering nickel powder, silver wire or copper wire. Embodiments of the adhesive may be the same as those of the adhesive of the heat conductive adhesive, and thus omitted herein.

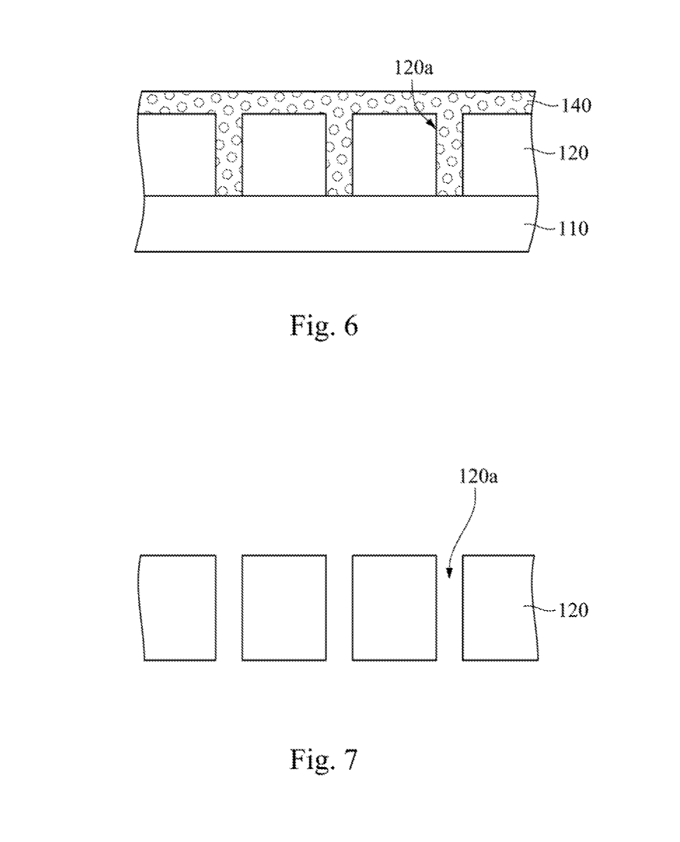

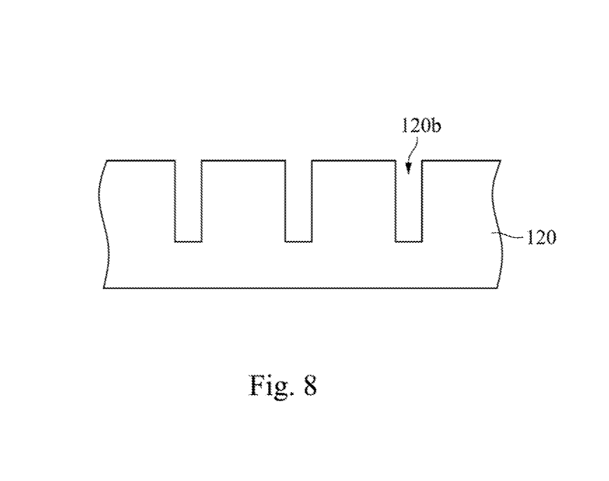

FIG. 6 is a cross-sectional view of a composite substrate according to one embodiment of the present disclosure. The difference between the composite substrates of FIGS. 6 and 5 is that the functional adhesive 140 of the composite substrate of FIG. 6 further covers the surface of the hole-containing insulating layer 120. When the functional adhesive 140 is the heat conductive adhesive, the composite substrate can provide x-y direction (i.e., planar direction) and z-direction heat conduction to exhibit excellent heat conductive performance. When the functional adhesive 140 is the electrically conductive adhesive, the composite substrate can provide x-y direction and z-direction electrical conduction to exhibit excellent electrically conductive performance.

The composite substrates of FIGS. 1-6 may be fabricated by film formation, patterning and lamination processes, The insulating layer or the adhesive layer may be formed by coating process, such as spin coating, slit coating, extrusion coating, curtain coating, swash plate coating or knife coating. Next, the patterning process, such as CNC mechanical drilling, micro punching using a mold, laser drilling or lithography and etching processes, is performed on the insulating layer to form the hole-containing insulating layer. If the composite substrate is a double-side substrate, another conductive layer may be laminated on the hole-containing insulating layer 120 of the composite substrate of FIG. 1 by lamination process to form the double-side substrate of FIG. 4.

The present disclosure also provides a hole-containing insulating layer for high frequency applications. FIG. 7 is a cross-sectional view of a hole-containing insulating layer for high frequency applications according to one embodiment of the present disclosure. The hole-containing insulating layer 120 includes a plurality of holes 120a extending from a surface of the hole-containing insulating layer 120 along a thickness direction Dt. The holes 120a are filled with air, which has dielectric constant of about 1, such that dielectric constant of the hole-containing insulating layer 120 is lower than that of an insulating layer without holes, so as to meet needs of dielectric constant of the insulating layer in the field of a high frequency substrate. In the embodiment, as shown in FIG. 7, the holes 120a are through holes. In another embodiment, the holes 120b are blind holes.

The method of manufacturing the hole-containing insulating layer 120, extension direction, size, distribution, shape in a top view, shape in a side view of the hole 120a and the material of the hole-containing insulating layer 120 may be referred to above embodiments of the hole-containing insulating layer 120, and thus omitted herein.

Given above, the present disclosure provides embodiments of the composite substrate, which includes the conductive layer and the hole-containing insulating layer. The composite substrate may be an adhesiveless (i.e., excluding adhesive layer) substrate or an adhesive-containing (i.e., including adhesive layer) substrate. The composite substrate may be a single-side substrate or a double-side substrate. It is important that the holes are filled with air, which has dielectric constant of about 1, such that dielectric constant of the hole-containing insulating layer 120 is lower than that of an insulating layer without holes, so as to meet needs of dielectric constant of the insulating layer in the field of a high frequency substrate. When the holes are filled with the heat conductive adhesive, the composite substrate has a function of heat conduction. When the holes are filled with electrically conductive adhesive, the composite substrate has a function of electrical conduction. Accordingly, the composite substrate of the present disclosure has various applications. The present disclosure also provides the embodiments of the hole-containing insulating layer for high frequency applications. The holes are filled with air, which has dielectric constant of about 1 such that the hole-containing insulating layer 120 has dielectric constant lower than that of an insulating layer without holes, and thus can be applied in high frequency applications.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A composite substrate, comprising:
a conductive layer; and
a hole-containing insulating layer, disposed on the conductive layer and having a plurality of holes extending from a surface of the hole-containing insulating layer along a thickness direction.

2. The composite substrate of claim wherein the holes are through holes or blind holes.

3. The composite substrate of claim 1, wherein the composite substrate is a high-frequency application composite substrate.

4. The composite substrate of claim 1, further comprising an adhesive layer interposed between the conductive layer and the hole-containing insulating layer.

5. The composite substrate of claim 1, further comprising another conductive layer covering the surface of the hole-containing insulating layer.

6. The composite substrate of claim 1, wherein the conductive layer is made of copper, aluminum, iron, silver, palladium, nickel, chromium, molybdenum, tungsten, zinc, chromium, manganese, cobalt, gold, tin, lead, stainless steel or a combination thereof.

7. The composite substrate of claim 1, wherein the hole-containing insulating layer is made of thermosetting polyimide, thermoplastic polyimide, liquid crystal polymer (LCP), polyethylene terephthalate (PET), Teflon, polyethylene (PE), polypropylene (PP), polystyrene (PS), polyvinyl chloride (PVC), polyamide, acrylic resin, acrylonitrile-butadiene-styrene (ABS) resin, phenolic resin, epoxy resin, polyester, silicone, polyurethane (PU), polycarbonate (PC), butyl rubber or a combination thereof.

8. The composite substrate of claim 1, further comprising a functional adhesive filled in the holes, and the functional adhesive is a heat conductive adhesive, an electrically conductive adhesive or a combination thereof.

9. The composite substrate of claim 8, wherein the functional adhesive further covers the surface of the hole-containing insulating layer.

10. The composite substrate of claim 8, wherein the heat conductive adhesive has a plurality of heat conductive particles, and the heat conductive particles are boron nitride, aluminum nitride, aluminum oxide, silicon carbide, zinc oxide or a combination thereof.

11. The composite substrate of claim 8, wherein the electrically conductive adhesive has a plurality of electrically conductive substances, and the electrically conductive substances are copper, aluminum, iron, silver, palladium, nickel, chromium, molybdenum, tungsten, zinc, chromium, manganese, cobalt, gold, tin, lead, stainless steel or a combination thereof.

12. A hole-containing insulating layer for high frequency applications having a plurality of holes extending from a surface of the hole-containing insulating layer along a thickness direction, in which the holes are through holes or blind holes.
